(19) United States
(12) Patent Application Publication
(10) Pub. No.: US 2012/0325084 A1
(43) Pub. Date: Dec. 27, 2012

(54) SYSTEMS AND METHODS FOR COLLECTING AND DEPOSITING PARTICULATE MATTER ONTO TISSUE SAMPLES

(76) Inventors: Kenneth G. Sexton, Pittsboro, NC (US); Harvey E. Jeffries, Chapel Hill, NC (US); Ilona Jaspers, Chapel Hill, NC (US); David H. Leith, Chapel Hill, NC (US); Glenn W. Walters, Durham, NC (US); Melanie Lynn Doyle-Eisele, Albuquerque, NM (US); Kim M. Lichtveld, Durham, NC (US); Sandra W. Irwin, Bridgewater, NJ (US); James J. Jetter, Apex, NC (US); Seth M. Ebersviller, Durham, NC (US); William Vizuete, Chapel Hill, NC (US); Jose Zavala Mendez, Chapel Hill, NC (US)

(21) Appl. No.: 13/559,004

(22) Filed: Jul. 26, 2012

Related U.S. Application Data
(63) Continuation of application No. PCT/US2011/023183, filed on Jan. 31, 2011.
(60) Provisional application No. 61/336,993, filed on Jan. 29, 2010.
(60) Provisional application No. 61/343,753, filed on May 3, 2010.

(51) Int. Cl. B03C 3/34; B03C 3/155

(52) U.S. Cl. 95/10; 96/58; 96/19; 95/69; 95/14; 95/8

(57) ABSTRACT

Electrostatic aerosol in vitro exposure systems and methods are disclosed and can be used for collecting and depositing particulate matter onto tissue without pre-concentration, and without any intermediate collection steps such as use in water or on a filter. The system can include an inlet configured to receive air containing particulate matter, a receptacle configured to hold one or more tissue samples, a porous membrane providing support for an air-liquid interface of the tissue sample, and an electrostatic precipitation area. Particulate matter contained in the air received at the inlet can be electrically charged in the electrostatic precipitation area and flowed over the tissue sample, where it can be collected and measured.

### CROSS-REFERENCE TO RELATED APPLICATIONS

This application is a continuation of and claims priority to PCT/US2011/023183 filed Jan. 31, 2011, which claims the benefit of and priority to U.S. Provisional Application No. 61/336,993, filed Jan. 29, 2010, and U.S. Provisional Application No. 61/343,753, filed May 3, 2010, the disclosures of which are incorporated herein by reference in their entireties.

### GOVERNMENT INTEREST

This invention was made with U.S. Government support under Grant No. R-829762-01-0 awarded by the Environmental Protection Agency. Thus, the U.S. Government has certain rights in the invention.

### TECHNICAL FIELD

The subject matter disclosed herein relates generally to systems and methods for collecting and depositing particulate matter onto cell samples. More particularly, the subject matter disclosed herein relates to systems and methods for in vitro exposure of a cultured human lung cells to particulate matter.

### BACKGROUND

It has been shown that particulate matter (PM) is responsible for a significant fraction of air pollution-induced health effects, including tens of thousands of deaths each year, particularly in the world's growing cities, yet there remain many questions concerning mechanisms of injury and what sources and components of this complex pollution are most responsible. For example, when scientists conduct conventional toxicology studies of known components of PM in a laboratory setting, they frequently find few health effects at exposure levels found in the air around us. This result is likely because people breathe a mixture of pollutants, many of which are unmeasured and are often created in the air via sunlight driven chemistry on emissions. In fact, studies have shown that when emissions are aged in sunlight, they become 5-10 times more harmful to human health than fresh emissions.

With these issues in mind, there have been efforts to develop testing in vitro systems and methods that can accurately replicate in vivo conditions to measure the effects of PM. Although in vitro models lack the ability to account for all intercellular interactions in the cells' natural environment, systems and methods that use in vitro exposure models may enable investigators to examine the effects of inhaled toxins on specific cell types, and thus can be valuable in determining potential cellular mechanisms mediating these responses.

Over the past several years, important advances have been made concerning developing in vitro exposure models that closely mimic in vivo exposures. In particular, several methods to conduct in vitro exposures to PM have been developed. All of these methods have known disadvantages, however, and may therefore not accurately represent PM-induced health effects in vivo. For instance, one of the most widely used methods for in vitro exposures to PM is to collect PM on filters, resuspend the collected PM in a liquid medium, and subsequently add the mixture to a cell culture. Filters collect particulate matter efficiently, and particles are easily resuspended in a liquid for subsequent contact with cells. Major shortcomings of filter collection, however, include the loss of volatile organic compounds (VOCs) from the PM, agglomeration of small particles during collection, and the possible alteration of the particles during the recovery process and while in the liquid medium. Likewise, impactors can be used to collect large-diameter PM on plates relatively efficiently, but VOCs can again be lost during collection, and, as with filters, the collected PM needs to be transferred to a liquid medium before use with cells. In addition, impactors can only be used to sample particles of relatively large diameter due low collection efficiency for small particles. Alternatively, impingers have been used to sample air containing PM through a liquid in which the particles are collected. Again, compounds and surface features of interest may be altered or lost by the particles' transfer into the liquid media. Once particles have been collected in the liquid medium in this manner, it is difficult to accurately determine the concentration of PM in solution—further reducing the utility of impinger collection for in vitro exposures. Recently, for example, an in vitro system using impaction to deposit PM directly onto cells was developed and tested. While this exposure system presents a much improved method for in vitro PM exposures, there remain a number of disadvantages—including the issue that impaction methods, while being efficient deposition methods for large particles, have a much lower utility for small particles.

Electrostatic precipitation (ESP) is a widely used method of PM collection and monitoring. Traditionally, ESP has been used as a method for aerosol collection in the control of airborne dust in residential and industrial settings. Particles are electrically charged and then subjected to a strong electric field that causes the particles to drift across the flow, and ultimately to deposit on a grounded collection plate. When PM is collected with ESP, the velocity perpendicular to the collection surface is orders of magnitude lower than that of an impactor sampling at the same flow rate. Even with such advantages, however, traditional methods of ESP are not well-suited for gentle collection and direct deposition of PM onto lung cells because exposure of cultured human lung cells requires an environment similar to that in the respiratory system, and epithelial cells may respond differently to the charged particles.

As a result, none of the existing systems and methods for in vitro exposure is able to accurately mimic in vivo exposures. In particular, no system and method yet developed has been able to adequately approximate the cellular mechanisms that mediate the effects of inhaled toxins on specific cell types.

### SUMMARY

In accordance with this disclosure, systems and methods for collecting and depositing particulate matter onto cell samples are provided. In one aspect, an electrostatic aerosol in vitro exposure system is provided for collecting and depositing particulate matter onto tissue without pre-concentration, and without any intermediate collection steps. The system can comprise an inlet configured to receive air containing particulate matter, a receptacle configured to hold one or more tissue samples, a porous membrane providing support for an air-liquid interface of the tissue sample, and an electrostatic precipitation area. The air received at the inlet can move through the electrostatic precipitation area and over the tissue sample.

In another aspect, a method of collecting particulate matter with an electrostatic aerosol in vitro exposure system is provided. The method can comprise providing a particulate collection apparatus comprising an inlet configured to receive air containing particulate matter, a receptacle configured to hold one or more tissue samples, a porous membrane providing support for an air-liquid interface of the tissue sample, and an electrostatic precipitation area. The method can further comprise electrically charging the particulate matter in the electrostatic precipitation area, flowing the air with electrically charged particulate matter about the tissue sample, and depositing the particulate matter onto the tissue sample. These steps can be accomplished by without pre-concentration of the particulate matter, and without any intermediate collection steps, such as for example use in water or on a filter.

In yet another aspect, a method of collecting particulate matter with an electrostatic aerosol in vitro exposure system is provided. The method can comprise supplying air containing particulate matter to a particulate collection apparatus containing a tissue sample, electrically charging the particulate matter in the particulate collection apparatus, flowing the air with electrically charged particulate matter about the tissue sample, and depositing the particulate matter directly onto the tissue sample. Again, these steps can be accomplished without pre-concentration of the particulate matter, and without any intermediate collection steps.

Although some of the objects of the subject matter disclosed herein have been stated hereinabove, and which are achieved in whole or in part by the presently disclosed subject matter, other objects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 is a side cutaway view of an electrostatic aerosol in vitro exposure system according to an embodiment of the presently disclosed subject matter;

FIG. 2 is a top cutaway view of an electrostatic aerosol in vitro exposure system according to an embodiment of the presently disclosed subject matter;

FIG. 3 is a side cutaway view of a tissue culture insert for use in an electrostatic aerosol in vitro exposure system according to an embodiment of the presently disclosed subject matter;

FIG. 4 is a side cutaway view of an electrostatic aerosol in vitro exposure system according to an embodiment of the presently disclosed subject matter;

FIG. 5 is a schematic of an environmental irradiation chamber in which is contained an electrostatic aerosol in vitro exposure system according to an embodiment of the presently disclosed subject matter;

FIG. 6 is a block diagram of an electrostatic aerosol in vitro exposure system according to an embodiment of the presently disclosed subject matter;

FIG. 7 is a graph showing histograms of particle number per size interval of particles exiting an electrostatic aerosol in vitro exposure system according to an embodiment of the presently disclosed subject matter in both a power-on state and a power-off state;

FIGS. 8A and 8B are graphs showing a comparison of cytotoxicity and inflammatory mediator production in cells exposed to clean air during operation of an electrostatic aerosol in vitro exposure system according to an embodiment of the presently disclosed subject matter versus a control environment; and

FIGS. 9A and 9B are graphs showing a comparison of cytotoxicity and inflammatory mediator production in cells exposed to particulate-containing air during operation of an electrostatic aerosol in vitro exposure system according to an embodiment of the presently disclosed subject matter versus a control environment.

### DETAILED DESCRIPTION

The present subject matter provides systems and methods for collecting and depositing particulate matter onto cell samples. In one aspect, the present subject matter provides an electrostatic aerosol in vitro exposure system that can both keep cells viable and deposit different types of PM on the cells gently and efficiently. As shown in FIG. 1, the system, generally designated 100, can comprise a particulate collection apparatus 110 having an inlet 112 and an outlet 114 providing access into and out of an interior space S of particulate collection apparatus 110.

Within interior space S, an electrostatic precipitation area 120 can comprise a repellant plate 122 and an opposing collection plate 124 (e.g., an anodized aluminum collection plate). A precipitation voltage can be established and maintained between collection plate 124 and repellant plate 122. For example, the precipitation voltage can be set to about 1.4 kilovolts, which can help to assure viability of the cells during collection of PM, whereas higher applied voltages can cause arcing between the plates and lower applied voltages can result in a lower collection efficiency. Further, electrostatic precipitation area 120 can also comprise a corona unit 130 that can be positioned before or in front of repellant plate 122 and collection plate 124 (i.e., nearer to inlet 112). Corona unit 130 can be used for charging PM that is received into particulate collection apparatus 110 through inlet 112. Specifically, corona system 130 can comprise a corona wire 132 and an opposing corona power plate 134, which can together be operable to impart a charge to PM passing therebetween. For example, corona wire 132 can be charged to a current of about 7.5 μA. In this way, particles received through inlet 112 can be electrically charged and then subjected to a strong electric field that causes the particles to drift across the flow and deposit on collection plate 124.

As can be appreciated, a corona wire, such as corona wire 132, may produce a small amount of ozone that could conceivably react with components of the exposure air stream and alter its chemical composition. For example, when operated with a corona current setting of 1.5 μA at a sample rate of 1 L/min, corona unit 130 of system 100, which is used to charge the particles, can produce an average of 60 ppb ozone in the exhaust air after 1 hour of operation. Besides this ozone exposure, it is recognized that there may also be concerns regarding the possibility that the electrical field applied in the sampler to cause particles to precipitate might adversely affect cells in the device.

Testing has shown, however, that even when corona unit 130 is operated at higher current settings as discussed above, the ozone produced and the precipitating field do not cause significant adverse effects on sample cells. Specifically, adjusting corona wire 132 to have a current of about 7.5 μA will charge the PM sufficiently for deposition in electrostatic precipitation area 120 while still mitigating ozone production. In addition, it is believed that no chemical reactions that produce carbonyls or that react with carbonyls occur as the exposure airstream passes through the system 100, nor is there observable particle production due to the ozone from the corona wire reacting with the d-limonene flowing through system 100.

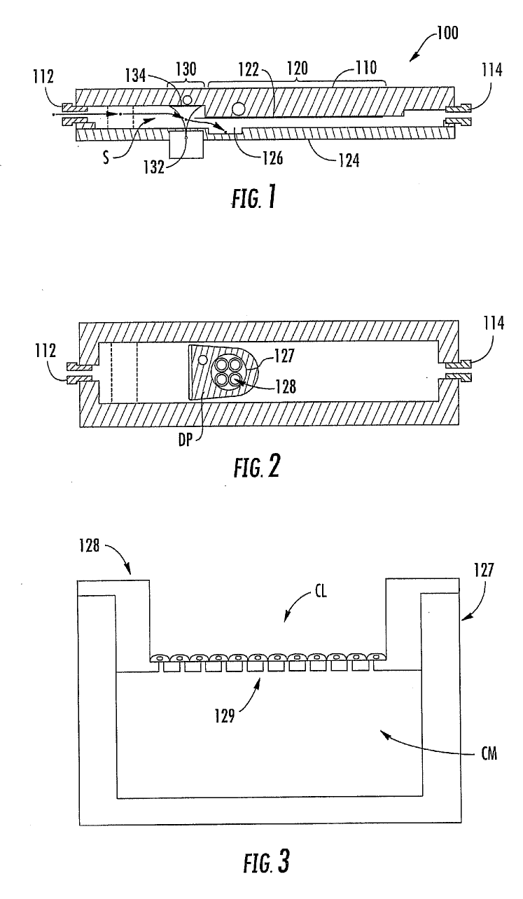

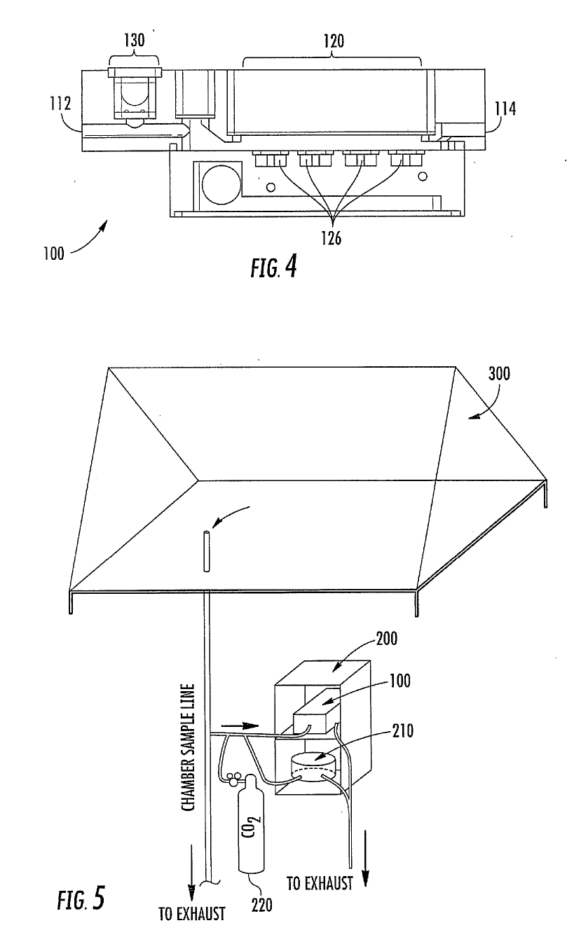

In addition, system 100 can further comprise one or more wells 126 (e.g., a circular well) formed in collection plate 124, such as by milling. For example, circular well 126 can be about 0.6 cm deep, 3.5 cm in diameter, and can be centered about 3.75 cm from corona wire 132. Positioned within circular well 126, a dish 127 can be configured to receive tissue culture media CM during the exposure. Dish 127 can be composed of titanium, which does not interfere with media CM because it is a nonreactive metal, and it can comprise a plurality of tissue culture inserts 128 (e.g., Millicells having 0.69 cm² surface area each), and example of which is shown in FIG. 3. For example, FIG. 2 shows dish 127 containing four such inserts 128. In addition, more than one well 126 can be formed in collection plate 124. (See, e.g., FIG. 4)

In one particular example, A549 cells, from a human epithelial lung cell line that has retained several alveolar type II cell characteristics, can be used as the sample placed in circular well 126. A cell layer CL of A549 cells can be grown on a collagen-coated porous membrane 129 in complete media (e.g., F12K media, 10% fetal bovine serum, with antibiotics [0.01% penicillin/streptomycin]). The depth of inserts 128 of dish 127 can sized (e.g., about 0.5 cm) to allow for the upper edges of tissue culture inserts 128 to be leveled with the edge of dish 127 in system 100. When the cells in cell layer CL reach confluency, and several hours before exposure, the complete media can be replaced with serum-free media (e.g., F12K media, 1.5 μg/ml bovine serum albumin, with antibiotics [0.01% penicillin/streptomycin]). Immediately before exposure in system 100, media can be removed from the apical side of the membrane, while media can remain in the basolateral side by contact with a porous membrane 129 that remains. Such an arrangement facilitates direct exposure of cell layer CL of lung epithelial cells to the sample delivered by system 100 across an air-liquid interface without significant interference from the culture media, while providing cell layer CL with nutrients from the serum free media from the basolateral side.

As shown in FIG. 5, system 100 can be housed in a tissue culture incubator 200 held at a desired temperature (e.g., about 37° C.). Incubator 200 can also house a lung cell gas exposure chamber 210. To prevent particle loss during the exposure, system 100 can be supplied (e.g., via inlet 112) with particle-containing air mixtures, such as by way of carbon-impregnated silicon tubing. Clean chamber air can be mixed with CO₂ from a carbon dioxide source 220 (e.g., to achieve 5% concentration). The mixture can be allowed to flow through system 100 for 1 hour or more as needed at 1 L/min (including CO₂ at 0.05 L/min) to conduct exposures with the system. Further, system 100 can be arranged in communication with an outdoor atmospheric reaction chamber 300, which can be used to “age” incoming emissions in sunlight to enable the measure of pollutants created in the air via sunlight driven chemistry on emissions. Particle-containing samples from outdoor atmospheric reaction chamber 300, or from other test sources, can also be mixed with CO₂ and can be pulled through the device at a constant flow rate of 1 L/min.

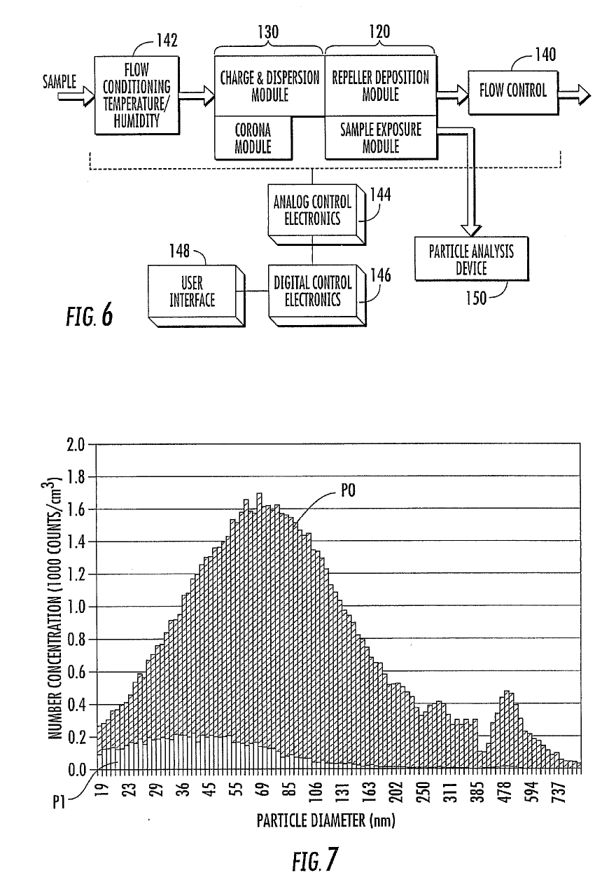

Regardless of the specific source or composition of the particle-containing air mixture provided to system 100, and as illustrated for example in FIG. 6, flow through system 100 can be controlled by a mass flow controller 140. Characteristics of the incoming flow can be controlled at a flow conditioning module 142 to be at desired levels. For example flow conditioning module 142 can comprise a temperature control device, a humidity control device, a carbon dioxide control device, or the like to carefully control the characteristics of the incoming flow, either alone or in combination with other external components (e.g., incubator 200). The operation of these components can be controlled by an analog control module 144 and/or a digital control module 146, each of which can be operated using a user interface 148.

In operation, while the electrical field was turned off, no significant particle deposition occurs within the device. When the electrical field is turned on, however, a large percentage of the particles that enter the device can be deposited, with the remaining portion exiting through outlet 114. Specifically, the particle collection efficiency can be determined to be approximately 90% for all particles between 19 nm and 882 nm, representing 98% of the total mass passing through the device. FIG. 7 shows exemplary scanning mobility particle sizer data as two histograms of number in each size range and illustrates the collection efficiency on the total collection plate of system 100, both with power off (P0) and with power on (P1). In addition, although dish 127 may occupy only a portion of collection plate 124, deposition analysis has shown that particles deposit efficiently over the cells, with about 36-48% of the mass depositing directly onto the tissue culture insert, thus resulting in an efficient exposure to submicrometer particles. To evaluate how even the deposition is, each cell culture insert mass can be calculated separately for each membranous support and can be shown to have similar mass deposition.

In this way, a sample received by system 100 can be directly deposited on cells maintained at the air-liquid interface without significant interference from culture media, while providing nutrients from the basolateral side. For instance, the entire recessed well can be positioned to be within a parabolic deposition pattern DP of the particles collected, which can facilitate relatively uniform particle deposition over the whole cell culture surface. The amount and kind of particulate matter deposited, as well as the chemical and physical characteristics of the particulate matter, can then be measured and analyzed by a particle analysis device 150 (e.g., a data correlation device).

In contrast to the systems and methods discussed above, traditional methods of in vitro particle exposure do not deposit particles in their original state directly onto cells, or they are entirely inefficient for deposition of fine and ultrafine particles. Methods that resuspend particles in solution may change the composition of the particles by losing the VOCs partitioned to the surface of the particles or by altering the surface characteristics. These collection methods can also alter the size distributions of the particles, leading to nonrealistic exposures.

As described herein, system 100 overcomes many of these shortcomings of the traditional methods without introducing new ones. Deposition of the particles onto the surface of cells grown on tissue culture inserts in system 100 can be based on deflection of electrically charged particles once they are subjected to an electric field. This methodology has been used extensively in the sampling and measurement of fine particles, and the charging and collection mechanisms have been well studied.

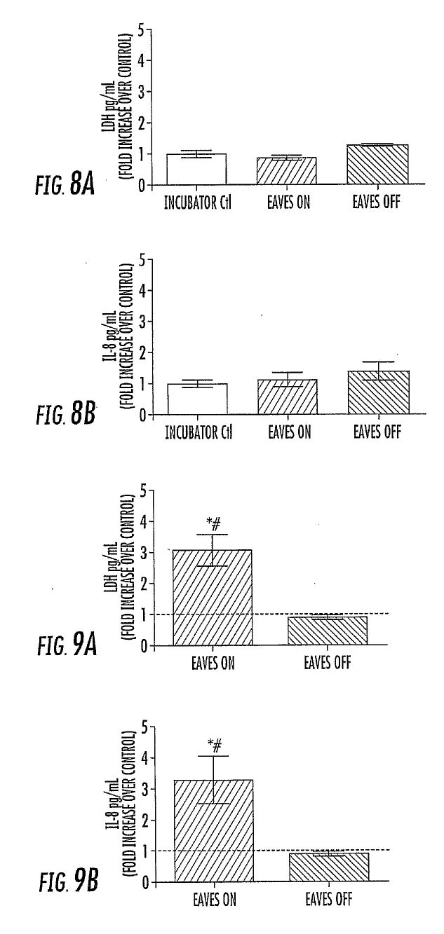

In addition, tests with human lung cells demonstrate that no significant cytotoxicity or inflammatory mediator production occurred to cells exposed in system 100 with clean air sampling, with or without the electric field applied. As shown in FIGS. 8A and 8B, for example, tests of inflammatory response and cytotoxicity of cells exposed to clean air conducted both while the electrical field was turned off for an extended period of time (e.g., 1 hour) and while the field was turned on for the same period produced results that were not statistically different from that of cells maintained in the incubator for an equivalent exposure period. Likewise, there are no responses to the low ozone concentration produced by the corona wire in system 100 (e.g., about 60 ppb). Neither the very small electrical charges nor the low deposition velocity (e.g., about 0.763 cm/s) of biologically inert particles deposited on the cells in system 100 cause a significant inflammatory response. Additional tests further demonstrate that even for a very reactive VOC like d-limonene, no detectable reaction occurs during air sample passage through the device, nor is any SOA formation apparent. Thus, there is no de novo production of particles.

To test system 100 with a realistic PM-containing atmospheric sample, it can be necessary to measure effects induced by exposure to PM samples that had also been assessed with other toxicity measurements. There are many studies demonstrating that exposure to diesel exhaust (DE), for example, using liquid resuspension can induce the production of inflammatory mediators, such as interleukin (IL)-8. As shown in FIGS. 9A and 9B, however, Cells exposed to DE in system 100 with the power turned off did not exhibit any change in inflammatory response over that of the control. Considering that no significant particle mass is precipitated when the device is turned off, these results are not surprising.

In contrast, referring again to FIGS. 9A and 9B, cells exposed to the same DE mixture with the electrostatic fields of system 100 turned on produced a threefold increase in both cytotoxicity and inflammatory mediator production as compared to the control. Similar results have been obtained in studies using DE particles resuspended in liquid medium. Typically, resuspension studies require between 50 and 400 μg/ml of DE particles resuspended in a medium to detect any significant inflammatory responses. By comparison, considering the deposition efficiency of system 100, the approximate mass of PM deposited onto each tissue culture insert during the DE exposure experiments with system 100 can be approximately 2.64±0.66 μg DE particles (4.18±1.04 μg/cm²), depending on sample and exposure times and alternative sample rates. These data indicate that exposure to DE particles using system 100 produces significant adverse cellular effects at the same or even lower particle concentrations and may therefore be more sensitive than traditional in vitro particle exposure methods.

Taken together, these data demonstrate that a well-designed and carefully operated electrostatic particle collection device, such as system 100 described here, is an excellent alternative to conventional exposure methods for in vitro exposures to air pollution mixtures containing particulate matter. This technology can allow investigators to expose cells in vitro to particle containing air streams without the need to collect and resuspend particles in a liquid before cell exposure. As a result, system 100 provides the ability to collect aerosols or particles sampled in air and deposit directly onto cultured cells for toxicological tests, in their original unaltered form and composition, without “pre-concentration”, without any intermediate collection steps such as is currently done, and to do this more uniformly with particle size, across a wide range of sizes of interest to health effects of air pollution. Current devices similar to this device, are limited in function to either very large or very small particles, or have a collection efficiency which is strongly affected by size, or overall sample size. Thus, system 100 is not only more efficient, but it avoids the possibility of altering the physicochemical characteristics of particles before exposure, thereby giving a more realistic evaluation of the possible human health effects of inhaled particulate matter.

In addition, the comparatively enhanced collection efficiency of system 100 relative to prior systems and methods, along with the ability to collect aerosols or particles in their original unaltered form and composition, can be desirable not only for measurements of toxicology, but also for assessments of the chemical and physical characteristics of the particles. For example, as discussed above and illustrated in FIG. 6, the amount and kind of particulate matter deposited can be measured and analyzed by a particle analysis device 150.

System 100 is revolutionary in a number of ways. It can be portable, so it can easily be located in an area where air quality is of concern or where people have experienced emissions-related health problems. By studying effects on the lung cells, such as inflammation or cell death, the health impacts and potential seriousness of the exposure can be understood. When used alongside traditional air monitoring equipment, system 100 can give direct, highly accurate correlations between established air quality measures and human health effects. System 100 can produce results that can be analyzed to discover the toxicity and composition of the toxic gases causing the damage, even if some of the gases are previously unknown and unmeasured. System 100 can give real-time results, enabling a rapid response to dangerous levels of air pollution. Finally, its sensitivity and superb collection efficiency are unmatched by other models currently in use.

In fact, the U.S. Environmental Protection Agency (EPA) can appreciate the breakthrough potential of the systems and methods disclosed herein, since they can enable the EPA to sensitively measure pollutant effects at concentration levels normally found in air, something not possible with devices currently on the market. Important applications of system 100 can include, for example and without limitation: determining how specific pollutants are affecting human health or to monitor “hot spots” near industrial sources; monitoring air quality in industrial, occupational, or mining worksites; monitoring ongoing air quality in hospitals, nursing homes, schools, dorms, and other environments with concentrations of potentially vulnerable groups; relating changes in air toxicity caused by traffic, smog, or industrial releases to increases in hospital admissions and emergency room visits for asthma, COPD, and other pollution-related conditions; assisting health care workers in distinguishing between chemical and other respiratory toxins (e.g., mold and insects) in order to provide more targeted prevention and care to patients; monitoring military bases, toxic sites, munitions manufacturing centers, and war zones for toxins and pollutants that affect troops and surrounding communities; providing surveillance of air quality following a natural disaster such as major fire, or following a 911-style terrorist attack; assessing air quality and safety following chlorine decontamination efforts (e.g., in the case of anthrax attacks); developing models that predict and rank the most toxic pollutants to guide pollution control policy and advocacy efforts; providing a humane alternative to animal studies of air pollutants such as smoke and motor vehicle exhaust; and helping toxicology researchers to understand the mechanisms of injuries caused by different toxins, and to study the health effects of different pollutants on various parts of the respiratory tract.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. An electrostatic aerosol in vitro exposure system for collecting and depositing particulate matter onto tissue without pre-concentration, and without any intermediate collection steps, the system comprising:
an inlet configured to receive air containing particulate matter;
a receptacle configured to hold one or more tissue samples;
a porous membrane providing support for an air-liquid interface of the tissue sample; and
an electrostatic precipitation area;
wherein air is movable through the electrostatic precipitation area and over the tissue sample.

2. The system of claim 1, wherein the electrostatic precipitation area comprises a collection plate and a repellant plate.

3. The system of claim 2, wherein the electrostatic precipitation area further comprises a preceding corona wire for charging the particulate matter.

4. The system of claim 3, wherein the collection plate is anodized.

5. The system of claim 4, wherein the collection plate comprises a well configured to hold the receptacle.

6. The system of claim 3, wherein the corona wire is charged to a current of 7.5 micro amps.

7. The system of claim 2, comprising a precipitation voltage of 1.4 kilovolts between the collection plate and the repellant plate.

8. The system of claim 2, wherein the electrostatic precipitation area is a heated area.

9. The system of claim 1, wherein the porous membrane is disposed between lung cells and growth medium.

10. The system of claim 1 further comprising a temperature control device.

11. The system of claim 1 further comprising a humidity control device.

12. The system of claim 1 further comprising a carbon dioxide control device.

13. The system of claim 1 further comprising an outlet device.

14. The system of claim 1 wherein the inlet comprises a stream from a carbon dioxide source.

15. The system of claim 1, wherein the system is adapted for functioning with a wide range of particle sizes, including large and small particles.

16. The system of claim 1, wherein the system has a collection efficiency minimally affected by size or overall particle size.

17. A method of collecting particulate matter with an electrostatic aerosol in vitro exposure system, the method comprising
providing a particulate collection apparatus comprising;
an inlet configured to receive air containing particulate matter;
a receptacle configured to hold one or more tissue samples;
a porous membrane providing support for an air-liquid interface of the tissue sample; and
an electrostatic precipitation area,
electrically charging the particulate matter in the electrostatic precipitation area;
flowing the air with electrically charged particulate matter about the tissue sample; and
depositing the particulate matter onto the tissue sample;
wherein the above steps are accomplished without pre-concentration of the particulate matter, and without any intermediate collection steps.

18. The method of claim 17 further comprising providing nutrients to the air-liquid interface of the tissue samples.

19. The method of claim 17 further comprising the step of maintaining the apparatus at an optimum temperature, humidity, and/or carbon dioxide level.

20. The method of claim 19, wherein the temperature is maintained at approximately 37° C.

21. The method of claim 17 further comprising analyzing the particulate matter deposited to measure one or more of toxicology, amount, chemical characteristics, and/or physical characteristics of the particulate matter.

22. The method of claim 17, wherein electrically charging the particulate matter comprises flowing the air containing particulate matter over a corona wire.

23. The method of claim 22, wherein the corona wire is charged to a current of approximately 7.5 micro amps.

24. The method of claim 22, wherein a current in the corona wire is adjustable.

25. The method of claim 17, wherein the precipitation area comprises a precipitation voltage of approximately 1.4 kilovolts maintained between a repellant plate and a collection plate.

26. The method of claim 17, wherein a precipitation voltage maintained between a repellant plate and a collection plate of the precipitation area is adjustable.

27. The method of claim 17, wherein depositing the particulate matter onto the tissue sample comprises depositing approximately 90% of all particles contained in the air having a size between 19 nm and 882 nm onto the receptacle.

28. A method of collecting particulate matter with an electrostatic aerosol in vitro exposure system, the method comprising:
supplying air containing particulate matter to a particulate collection apparatus containing a tissue sample;
electrically charging the particulate matter in the particulate collection apparatus;
flowing the air with electrically charged particulate matter about the tissue sample; and
depositing the particulate matter onto the tissue sample;
wherein the above steps are accomplished without pre-concentration of the particulate matter, and without any intermediate collection steps.

29. The method of claim 28, wherein depositing the particulate matter onto the tissue sample comprises depositing approximately 90% of all particles contained in the air having a size between 19 nm and 882 nm onto a receptacle on which the tissue sample is held.

30. The method of claim 28, further comprising analyzing the particulate matter deposited to measure one or more of toxicology, amount, chemical characteristics, and/or physical characteristics of the particulate matter.
